(19) United States
(12) Patent Application Publication
(10) Pub. No.: US 2020/0151720 A1
(43) Pub. Date: May 14, 2020

(54) ASSET TRANSFER METHOD AND APPARATUS, AND ELECTRONIC DEVICE

(71) Applicant: Alibaba Group Holding Limited, George Town (KY)

(72) Inventors: Danqing Hu, Hangzhou (CN); Sen Lin, Hangzhou (CN); Junliang Zhang, Hangzhou (CN)

(73) Assignee: Alibaba Group Holding Limited, George Town (KY)

(21) Appl. No.: 16/739,420

(22) Filed: Jan. 10, 2020

Related U.S. Application Data
(62) Division of application No. 16/425,306, filed on May 29, 2019.

(30) Foreign Application Priority Data
May 29, 2018 (CN) 201810535430.1

(51) Int. Cl. G06Q 20/40; G06Q 20/10

(52) U.S. Cl. CPC G06Q 20/401; G06Q 2220/00; G06Q 20/10

(57) ABSTRACT

This specification describes techniques for transferring assets between blockchain members. A request for transferring a first amount of blockchain assets between a first user and a second user is received by a first blockchain member of a blockchain. A second blockchain member corresponding to the second user, and a plurality of intermediate blockchain members between the first blockchain member and the second blockchain member are determined by the first blockchain member, where adjacent blockchain members respectively hold blockchain assets issued by a same anchor point. An asset transfer contract operation is initiated by the first blockchain member and based on an asset transfer condition published by each intermediate blockchain member. Whether the asset transfer contract operation takes effect is determined by the first blockchain member. In response to determining that the asset transfer contract operation takes effect, an atomic transaction is performed by the first blockchain member.

### CROSS-REFERENCE TO RELATED APPLICATIONS

This application is a division of U.S. patent application Ser. No. 16/425,306, filed on May 29, 2019, which claims priority to Chinese Patent Application No. 201810535430.1, filed on May 29, 2018, and each application is incorporated by reference in its entirety.

### TECHNICAL FIELD

One or more implementations of the present specification relate to the field of terminal technologies, and in particular, to an asset transfer method and apparatus, and an electronic device.

### BACKGROUND

In related technologies, a solution to asset transfer through a blockchain network is provided. For example, asset transfer is performed between different blockchain members, and asset transfer is performed between a plurality of accounts of one blockchain member. Asset transfer can be directly performed between a payer and a payee of assets or can be performed between a payer and a payee by using another blockchain member as an intermediate member. It depends on the assets of the payer and the payee.

### SUMMARY

In view of this, one or more implementations of the present specification provide an asset transfer method and apparatus, and an electronic device.

To achieve the previous objective, one or more implementations of the present specification provide the following technical solutions:

According to a first aspect of one or more implementations of the present specification, an asset transfer method is provided, including: receiving, by a first blockchain member, a request for transferring a first amount of assets between a payer and a payee; determining, by the first blockchain member, a second blockchain member corresponding to the payee, and several intermediate blockchain members between the first blockchain member and the second blockchain member, where adjacent blockchain members respectively hold blockchain assets issued by a same anchor point; and initiating, by the first blockchain member, an asset transfer contract operation based on an asset transfer condition published by each intermediate blockchain member, so that after the asset transfer contract operation takes effect, the following operations are completed in a same atomic transaction: each intermediate blockchain member receives, based on blockchain assets that are issued by a first anchor point and are respectively held by the intermediate blockchain member and an upstream neighboring blockchain member, a first amount of blockchain assets that are issued by the first anchor point and are transferred from the upstream neighboring blockchain member, and transfers, based on blockchain assets that are issued by a second anchor point and are respectively held by the intermediate blockchain member and a downstream neighboring blockchain member, a second amount of blockchain assets issued by the second anchor point to the downstream neighboring blockchain member, where the asset transfer condition is used to indicate a numerical relationship between transferred-in assets of a corresponding intermediate blockchain member on the first anchor point and transferred-out assets of the intermediate blockchain member on the second anchor point, so that the first amount and the second amount satisfy the numerical relationship.

According to a second aspect of one or more implementations of the present specification, an asset transfer method is provided, including: creating, by a blockchain member, an asset transfer condition, where the asset transfer condition is used to indicate a numerical relationship between transferred-in assets and transferred-out assets of the blockchain member when asset transfer is performed; and publishing, by the blockchain member, the asset transfer condition in a blockchain, so that when the blockchain member acts as an intermediate blockchain member to implement asset transfer between a payer and a payee, the blockchain member and a first blockchain member used as an upstream neighbor respectively hold blockchain assets issued by a first anchor point, and the blockchain member and a second blockchain member used as a downstream neighbor respectively hold blockchain assets issued by a second anchor point, blockchain assets that are issued by the first anchor point and are transferred from the first blockchain member to the blockchain member and blockchain assets that are issued by the second anchor point and are transferred from the blockchain member to the second blockchain member satisfy the numerical relationship indicated by the asset transfer condition.

According to a third aspect of one or more implementations of the present specification, an asset transfer apparatus is provided, including: a receiving unit, enabling a first blockchain member to receive a request for transferring a first amount of assets between a payer and a payee; a determining unit, enabling the first blockchain member to determine a second blockchain member corresponding to the payee, and several intermediate blockchain members between the first blockchain member and the second blockchain member, where adjacent blockchain members respectively hold blockchain assets issued by a same anchor point; and an initiating unit, enabling the first blockchain member to initiate an asset transfer contract operation based on an asset transfer condition published by each intermediate blockchain member, so that after the asset transfer contract operation takes effect, the following operations are completed in a same atomic transaction: each intermediate blockchain member receives, based on blockchain assets that are issued by a first anchor point and are respectively held by the intermediate blockchain member and an upstream neighboring blockchain member, a first amount of blockchain assets that are issued by the first anchor point and are transferred from the upstream neighboring blockchain member, and transfers, based on blockchain assets that are issued by a second anchor point and are respectively held by the intermediate blockchain member and a downstream neighboring blockchain member, a second amount of blockchain assets issued by the second anchor point to the downstream neighboring blockchain member, where the asset transfer condition is used to indicate a numerical relationship between transferred-in assets of a corresponding intermediate blockchain member on the first anchor point and transferred-out assets of the intermediate blockchain member on the second anchor point, so that the first amount and the second amount satisfy the numerical relationship.

According to a fourth aspect of one or more implementations of the present specification, an asset transfer apparatus is provided, including: a creating unit, enabling a blockchain member to create an asset transfer condition, where the asset transfer condition is used to indicate a numerical relationship between transferred-in assets and transferred-out assets of the blockchain member when asset transfer is performed; and a publishing unit, enabling the blockchain member to publish the asset transfer condition in a blockchain, so that when the blockchain member acts as an intermediate blockchain member to implement asset transfer between a payer and a payee, the blockchain member and a first blockchain member used as an upstream neighbor respectively hold blockchain assets issued by a first anchor point, and the blockchain member and a second blockchain member used as a downstream neighbor respectively hold blockchain assets issued by a second anchor point, blockchain assets that are issued by the first anchor point and are transferred from the first blockchain member to the blockchain member and blockchain assets that are issued by the second anchor point and are transferred from the blockchain member to the second blockchain member satisfy the numerical relationship indicated by the asset transfer condition.

According to a fifth aspect of one or more implementations of the present specification, an electronic device is provided, including: a processor; and a memory, configured to store an instruction that can be executed by the processor, where the processor is configured to implement the method according to any one of the previous implementations.

### BRIEF DESCRIPTION OF DRAWINGS

FIG. 1 is a flowchart illustrating an asset transfer method, according to an example implementation;

FIG. 2 is a flowchart illustrating another asset transfer method, according to an example implementation;

FIG. 3 is a schematic diagram illustrating a remittance scenario, according to an example implementation;

FIG. 4 is a schematic diagram illustrating determining of a remittance route, according to an example implementation;

FIG. 5 is a schematic diagram illustrating performing of a remittance operation, according to an example implementation;

FIG. 6 is a schematic diagram illustrating asset transfer involving a plurality of types of assets, according to an example implementation;

FIG. 7 is a schematic diagram illustrating performing of an asset transfer operation, according to an example implementation;

FIG. 8 is a schematic structural diagram illustrating a device, according to an example implementation;

FIG. 9 is a block diagram illustrating an asset transfer apparatus, according to an example implementation;

FIG. 10 is a schematic structural diagram illustrating another device, according to an example implementation;

FIG. 11 is a block diagram illustrating another asset transfer apparatus, according to an example implementation; and

FIG. 12 is a flowchart illustrating an example of a computer-implemented method for transferring assets in a blockchain network, according to an implementation of the present disclosure.

### DESCRIPTION OF IMPLEMENTATIONS

Example implementations are described in detail here, and examples of the implementations are presented in the accompanying drawings. When the following description relates to the accompanying drawings, unless specified otherwise, the same numbers in different accompanying drawings represent same or similar elements. Implementations described in the following example implementations do not represent all implementations consistent with one or more implementations of the present specification. On the contrary, the implementations are only examples of apparatuses and methods that are described in the appended claims in detail and that are consistent with some aspects of one or more implementations of the present specification.

It is worthwhile to note that, in other implementations, steps of a corresponding method are not necessarily performed in an order shown and described in the present specification. In some other implementations, the method can include steps more or fewer than the steps described in the present specification. In addition, a single step described in the present specification can be divided into a plurality of steps for description in another implementation, and a plurality of steps described in the present specification can be combined into a single step for description in another implementation.

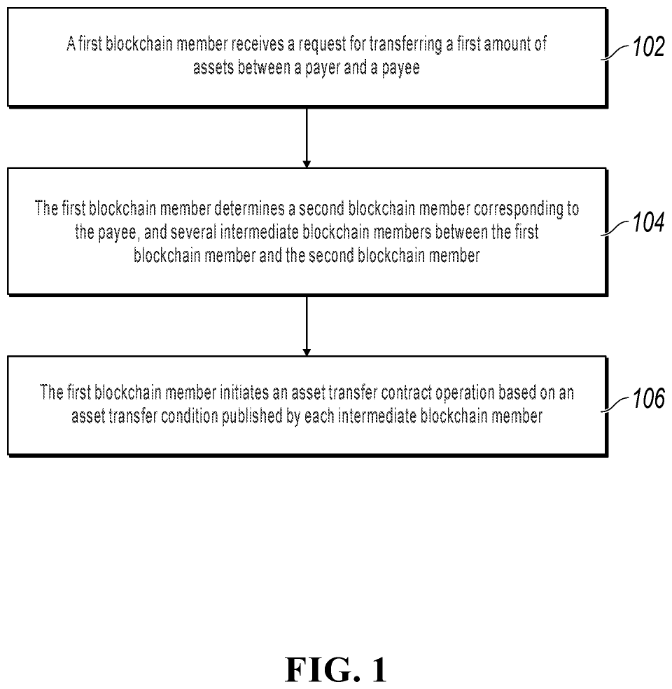

FIG. 1 is a flowchart illustrating an asset transfer method, according to an example implementation. As shown in FIG. 1, the method can include the steps below.

Step 102. A first blockchain member receives a request for transferring a first amount of assets between a payer and a payee.

In an implementation, “assets” in the present specification can include any type of asset, for example, cash, securities, and stocks, or devices, vehicles, properties, and goods. No limitation is imposed in the present specification.

In an implementation, the asset transfer request can be initiated by the first blockchain member. In other words, the first blockchain member can initiate the asset transfer request, and perform, based on the asset transfer solution in the present specification, transfer between blockchain assets deposited by the first blockchain member on a first anchor point and blockchain assets deposited by a second blockchain member on a second anchor point, to implement asset transfer between the payer and the payee. For example, the payer pays the first blockchain member off-chain assets, the first blockchain member transfers corresponding blockchain assets to the second blockchain member, and the second blockchain member pays the payee off-chain assets. It is finally equivalent to that the payer pays the payee off-chain assets.

In an implementation, the asset transfer request can be initiated by another member (such as a second blockchain member) in the blockchain. In other words, the another member can initiate the asset transfer request, and perform, based on the asset transfer solution in the present specification, transfer between blockchain assets deposited by the first blockchain member on a first anchor point and blockchain assets deposited by the second blockchain member on a second anchor point, to implement asset transfer between the payer and the payee.

Step 104. The first blockchain member determines a second blockchain member corresponding to the payee, and several intermediate blockchain members between the first blockchain member and the second blockchain member, where adjacent blockchain members respectively hold blockchain assets issued by the same anchor point.

In an implementation, the blockchain can include several blockchain nodes, and these blockchain nodes can include blockchain members (or briefly referred to as members) and anchor points. A blockchain member can play the role of the anchor point, or the anchor point can be irrelevant to the blockchain member, that is, the blockchain member does not necessarily play the role of the anchor point.

In an implementation, the blockchain member can be a financial institution or another form of organization or platform that supports the asset transfer service. No limitation is imposed in the present specification.

In an implementation, the anchor point is used to anchor the blockchain assets on the blockchain and off-chain assets outside the blockchain, so that off-chain assets can be exchanged for equivalent blockchain assets by using the anchor point, or blockchain assets can be exchanged for equivalent off-chain assets by using the anchor point, to implement one-to-one mapping between blockchain assets and off-chain assets. For example, a blockchain member can deposit off-chain assets on an anchor point, and obtain and hold corresponding blockchain assets issued by the anchor point in the blockchain. In addition, blockchain members can further transfer their held blockchain assets to each other. The holding status and the changes of blockchain assets that are held by each blockchain member and are issued by each anchor point can be recorded on a blockchain ledger of the blockchain, to facilitate unified management of blockchain assets.

Step 106. The first blockchain member initiates an asset transfer contract operation based on an asset transfer condition published by each intermediate blockchain member, so that after the asset transfer contract operation takes effect, the following operations are completed in a same atomic transaction: each intermediate blockchain member receives, based on blockchain assets that are issued by a first anchor point and are respectively held by the intermediate blockchain member and an upstream neighboring blockchain member, a first amount of blockchain assets that are issued by the first anchor point and are transferred from the upstream neighboring blockchain member, and transfers, based on blockchain assets that are issued by a second anchor point and are respectively held by the intermediate blockchain member and a downstream neighboring blockchain member, a second amount of blockchain assets issued by the second anchor point to the downstream neighboring blockchain member, where the asset transfer condition is used to indicate a numerical relationship between transferred-in assets of a corresponding intermediate blockchain member on the first anchor point and transferred-out assets of the intermediate blockchain member on the second anchor point, so that the first amount and the second amount satisfy the numerical relationship.

In an implementation, a unified blockchain ledger is used in the blockchain, and the blockchain ledger records an amount of blockchain assets that are held by each member and are issued by each anchor point. As such, after the asset transfer contract operation is initiated, balances of the first blockchain member, the second blockchain member, and each intermediate blockchain member can be changed together based on the contract operation. The same transaction is completed through cooperation between different institutions, and the asset transfer operation is completed in the same atomic transaction, instead of sequentially performing asset transfer between members. It greatly improves asset transfer efficiency, making it possible to perform real-time, quasi-real-time, or near real-time asset transfer.

In an implementation, the asset transfer condition is published in the blockchain. Because the information in the blockchain is tamper-proof and traceable, the asset transfer condition recorded on the blockchain ledger can be reliable enough to be trusted by all blockchain members and anchor points and can be used as an operating basis in various asset transfer scenarios such as transfer and payment.

In an implementation, there can be one intermediate blockchain member between the first blockchain member and the second blockchain member. In this case, the first blockchain member is an upstream neighboring blockchain member of the intermediate blockchain member, and the second blockchain member is a downstream neighboring blockchain member of the intermediate blockchain member. Both the first blockchain member and the intermediate blockchain member hold blockchain assets issued by the first anchor point, and both the intermediate blockchain member and the second blockchain member hold blockchain assets issued by the second anchor point. Therefore, if asset transfer is implemented by using the intermediate blockchain member, an asset transfer condition published by the intermediate blockchain member needs to be satisfied: If the first blockchain member transfers a first amount of blockchain assets issued by the first anchor point to the intermediate blockchain member, and the intermediate blockchain member transfers a second amount of blockchain assets issued by the second anchor point to the second blockchain member, the first amount and the second amount should satisfy a numerical relationship indicated by the asset transfer condition.

In an implementation, there can be a plurality of intermediate blockchain members between the first blockchain member and the second blockchain member, for example, the first blockchain member-a first intermediate blockchain member-a second intermediate blockchain member-a third intermediate blockchain member-the second blockchain member. For the first intermediate blockchain member, an upstream neighboring blockchain member is the first blockchain member, and a downstream neighboring blockchain member is the second intermediate blockchain member. For the second intermediate blockchain member, an upstream neighboring blockchain member is the first intermediate blockchain member, and a downstream neighboring blockchain member is the third intermediate blockchain member. For the third intermediate blockchain member, an upstream neighboring blockchain member is the second intermediate blockchain member, and a downstream neighboring blockchain member is the second blockchain member. Both the first blockchain member and the first intermediate blockchain member hold blockchain assets issued by the first anchor point. Both the first intermediate blockchain member and the second intermediate blockchain member hold blockchain assets issued by the second anchor point. Both the second intermediate blockchain member and the third intermediate blockchain member hold blockchain assets issued by a third anchor point. Both the third intermediate blockchain member and the second blockchain member hold blockchain assets issued by a fourth anchor point. Each of the first intermediate blockchain member, the second intermediate blockchain member, and the third intermediate blockchain member can publish a corresponding asset transfer condition. For example, the first intermediate blockchain member publishes a first asset transfer condition, the second intermediate blockchain member publishes a second asset transfer condition, and the third intermediate blockchain member publishes a third asset transfer condition. The first asset transfer condition, the second asset transfer condition, and the third asset transfer condition respectively include numerical relationships specified by the first intermediate blockchain member, the second intermediate blockchain member, and the third intermediate blockchain member. Therefore, if asset transfer is implemented by using the previous intermediate blockchain members, the corresponding first asset transfer condition, second asset transfer condition, and third asset transfer condition need to be satisfied.

If the first blockchain member transfers a first amount of blockchain assets issued by the first anchor point to the first intermediate blockchain member, and the first intermediate blockchain member transfers a second amount of blockchain assets issued by the second anchor point to the second intermediate blockchain member, the first amount and the second amount should satisfy the numerical relationship indicated by the first asset transfer condition.

If the first intermediate blockchain member transfers a second amount of blockchain assets issued by the second anchor point to the second intermediate blockchain member, and the second intermediate blockchain member transfers a third amount of blockchain assets issued by the third anchor point to the third intermediate blockchain member, the second amount and the third amount should satisfy the numerical relationship indicated by the second asset transfer condition.

If the second intermediate blockchain member transfers a third amount of blockchain assets issued by the third anchor point to the third intermediate blockchain member, and the third intermediate blockchain member transfers a fourth amount of blockchain assets issued by the fourth anchor point to the second blockchain member, the third amount and the fourth amount should satisfy the numerical relationship indicated by the third asset transfer condition.

Similarly, in another implementation, there can be another quantity of intermediate blockchain members. Provided that an asset transfer condition published by each intermediate blockchain member is obtained and the asset transfer conditions published by these intermediate blockchain members are satisfied in the asset transfer process, it can be ensured that asset transfer is successfully completed.

In an implementation, the asset transfer condition can include: a ratio of an amount of the transferred-out assets to an amount of the transferred-in assets is a predetermined ratio. For example, if the ratio of the amount of the transferred-out assets to the amount of the transferred-in assets is set to 99.90%, it indicates that the intermediate blockchain member needs to charge 0.10% of the total assets in the asset transfer process. Certainly, the intermediate blockchain member can set the predetermined ratio based on an actual need.

In an implementation, the asset transfer condition includes: an amount of the transferred-out assets is less than an amount of the transferred-in assets by a predetermined value. For example, if it is set that the amount of the transferred-out assets is less than the amount of the transferred-in assets by 100 RMB, it indicates that the intermediate blockchain member needs to charge 100 RMB per transaction in the asset transfer process. Certainly, the intermediate blockchain member can set the predetermined value based on an actual need.

In an implementation, the numerical relationship indicated by the asset transfer condition is related to at least one of the following dimensions: an asset type of the transferred-in assets, an asset type of the transferred-out assets, whether the first anchor point and the second anchor point are a same anchor point, a management party of the first anchor point, a management party of the second anchor point, a value range of the first amount, a category of the payer, and a category of the payee. In other words, the intermediate blockchain member can combine the one or more dimensions to obtain several corresponding asset transfer scenarios, and set corresponding asset transfer conditions for different asset transfer scenarios (numerical relationships indicated by different asset transfer conditions can be separately set and do not interfere with each other). As such, different asset transfer fees are charged in different scenarios.

In an implementation, when the first anchor point is different from the second anchor point, and the asset type of the transferred-in assets on the first anchor point is the same as the asset type of the transferred-out assets on the second anchor point, the asset transfer condition is equivalent to that a transfer fee is set for performing asset transfer between the first anchor point and the second anchor point.

In an implementation, when the first anchor point and the second anchor point are the same anchor point, and the asset type of the transferred-in assets is different from the asset type of the transferred-out assets, the asset transfer condition is equivalent to that an exchange rate is set for exchanging assets on the anchor point.

In an implementation, when the first anchor point is different from the second anchor point, and the asset type of the transferred-in assets on the first anchor point is different from the asset type of the transferred-out assets on the second anchor point, the asset transfer condition is equivalent to that a transfer fee and an exchange rate are set for performing asset transfer between the first anchor point and the second anchor point.

In an implementation, the asset transfer solution in the present specification can be applied to various asset transfer scenarios such as domestic asset transfer and cross-border asset transfer. No limitation is imposed in the present specification.

In an implementation, the blockchain in the present specification can be a consortium blockchain, each member participating in asset transfer is a consortium member of the consortium chain, and the consortium chain can further include more other consortium members. No limitation is imposed in the present specification.

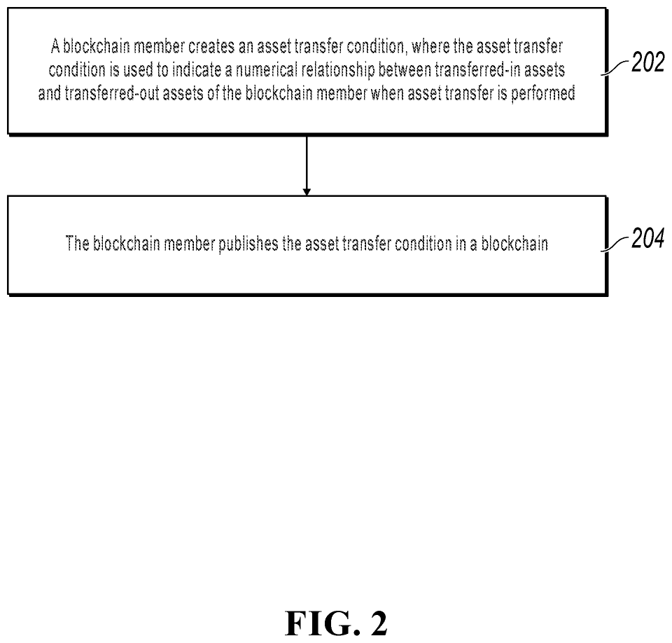

FIG. 2 is a flowchart illustrating another asset transfer method, according to an example implementation. As shown in FIG. 2, the method can include the steps below.

Step 202. A blockchain member creates an asset transfer condition, where the asset transfer condition is used to indicate a numerical relationship between transferred-in assets and transferred-out assets of the blockchain member when asset transfer is performed.

In an implementation, when a first anchor point is different from a second anchor point, and an asset type of the transferred-in assets on the first anchor point is the same as an asset type of the transferred-out assets on the second anchor point, the asset transfer condition is equivalent to that a transfer fee is set for performing asset transfer between the first anchor point and the second anchor point.

In an implementation, when a first anchor point and a second anchor point are the same anchor point, and an asset type of the transferred-in assets is different from an asset type of the transferred-out assets, the asset transfer condition is equivalent to that an exchange rate is set for exchanging assets on the anchor point.

In an implementation, when a first anchor point is different from a second anchor point, and an asset type of the transferred-in assets on the first anchor point is different from an asset type of the transferred-out assets on the second anchor point, the asset transfer condition is equivalent to that a transfer fee and an exchange rate are set for performing asset transfer between the first anchor point and the second anchor point.

In an implementation, the numerical relationship indicated by the asset transfer condition is related to at least one of the following dimensions: the asset type of the transferred-in assets, the asset type of the transferred-out assets, whether the first anchor point and the second anchor point are a same anchor point, a management party of the first anchor point, a management party of the second anchor point, a value range of a first amount, a category of a payer, and a category of a payee. In other words, an intermediate blockchain member can combine the one or more dimensions to obtain several corresponding asset transfer scenarios, and set corresponding asset transfer conditions for different asset transfer scenarios (numerical relationships indicated by different asset transfer conditions can be separately set and do not interfere with each other). As such, different asset transfer fees are charged in different scenarios.

Step 204. The blockchain member publishes the asset transfer condition in a blockchain, so that when the blockchain member acts as an intermediate blockchain member to implement asset transfer between a payer and a payee, the blockchain member and a first blockchain member used as an upstream neighbor respectively hold blockchain assets issued by a first anchor point, and the blockchain member and a second blockchain member used as a downstream neighbor respectively hold blockchain assets issued by a second anchor point, blockchain assets that are issued by the first anchor point and are transferred from the first blockchain member to the blockchain member and blockchain assets that are issued by the second anchor point and are transferred from the blockchain member to the second blockchain member satisfy the numerical relationship indicated by the asset transfer condition.

In an implementation, the blockchain member can create the asset transfer condition when remaining assets that are held by the blockchain member and are respectively issued by the first anchor point and the second anchor point satisfy a predetermined condition, to implement asset transfer between the first anchor point and the second anchor point. The predetermined condition includes: the remaining assets that are held by the blockchain member and are issued by the second anchor point are not less than a first predetermined amount, to ensure that the blockchain member has a sufficient amount of assets to transfer assets from the second anchor point; and a remaining amount of assets that can be transferred to the blockchain member and are issued by the first anchor point is not less than a second predetermined amount, to ensure that the blockchain member can receive a sufficient amount of assets issued by the first anchor point.

A maximum trusted asset amount can be set for the first anchor point based on the blockchain member's trustiness to the first anchor point. A larger maximum trusted asset amount indicates greater trustiness that the blockchain member has in the first anchor point. That is, the blockchain member believes that the first anchor point can exchange the maximum trusted asset amount of blockchain assets into off-chain assets. Based on the maximum trusted asset amount that is set by the blockchain member for the first anchor point and an amount of blockchain assets that are issued by the first anchor point and are held by the blockchain member, the remaining amount (a difference between the maximum trusted asset amount and the amount of the held blockchain assets) of assets that can be transferred to the blockchain member can be determined. Similarly, the blockchain member can also set a maximum trusted asset amount for the second anchor point or another anchor point. Details are omitted here.

The first anchor point is used as an example. It is worthwhile to note that, when the first anchor point supports a plurality of types of assets, the blockchain member can set a maximum trusted asset amount for each type of asset, and the blockchain member can also set a total maximum trusted asset amount for the first anchor point. As such, the maximum trusted asset amount corresponding to each type of asset and the total maximum trusted asset amount corresponding to all types of assets can be used to implement reliable asset management.

In an implementation, as assets that are held by the blockchain member and are respectively issued by the first anchor point and the second anchor point change, whether the remaining blockchain assets that are held by the blockchain member and are respectively issued by the first anchor point and the second anchor point can satisfy the predetermined condition also changes repeatedly. When the remaining blockchain assets do not satisfy the predetermined condition, the blockchain member can set the asset transfer condition to an invalid state, so that the blockchain member cannot perform a corresponding asset transfer operation based on the asset transfer condition. When the remaining blockchain assets satisfy the predetermined condition, the blockchain member can set the asset transfer condition to a valid state, so that the blockchain member can perform a corresponding asset transfer operation based on the asset transfer condition.

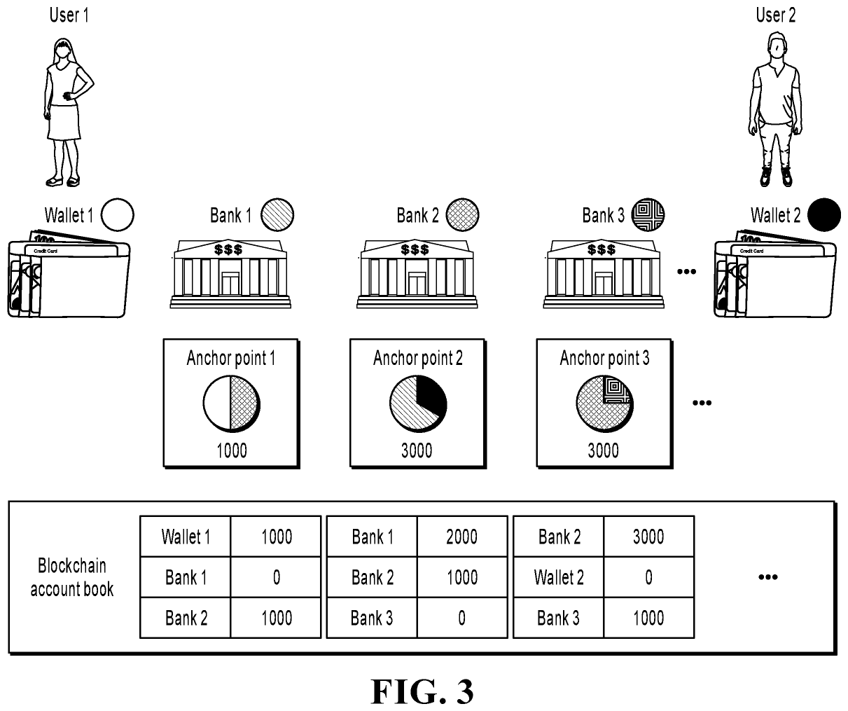

For ease of understanding, the following describes a technical solution of one or more implementations of the present specification by using a “remittance” process as an example. FIG. 3 is a schematic diagram illustrating a remittance scenario, according to an example implementation. As shown in FIG. 3, assume that a third-party payment platform operates wallet 1 in place A and operates wallet 2 in place B. User 1 in place A opens customer account 1 in wallet 1, and user 2 in place B opens customer account 2 in wallet 2. Remittance can be quickly implemented between user 1 and user 2 based on the money transfer solution in the present specification.

In an implementation, assume that wallet 1, wallet 2, bank 1, bank 2, and bank 3 shown in FIG. 3 are members in the same blockchain, and the blockchain can include several anchor points such as anchor point 1, anchor point 2, and anchor point 3 shown in FIG. 3. The member plays the role of the anchor point. For example, anchor points 1 to 3 in FIG. 3 respectively correspond to banks 1 to 3. Certainly, the member can be the anchor point or not, and the anchor point is not necessarily a member, that is, there is no one-to-one mapping between members and anchor points. Members such as wallets 1 and 2 and banks 1 to 3, and anchor points 1 to 3 are all nodes in the blockchain, and these nodes implement distributed accounting in the blockchain.

To implement remittance between user 1 and user 2 by using each member in the blockchain, wallets 1 and 2 and banks 1 to 3 need to join a contract corresponding to the “remittance” service in advance, for example, here referred to as a remittance contract. Each member can deposit any amount of money on each anchor point, a corresponding anchor point can issue corresponding blockchain assets in the blockchain, and the member that deposits the money holds the blockchain assets, to form a blockchain balance of the member. For example, after wallet 1 deposits 1000 RMB off-chain assets on anchor point 1, anchor point 1 can issue 1000 RMB blockchain assets, and wallet 1 holds the 1000 RMB blockchain assets. In addition, different members can transfer their held blockchain assets to each other. For example, although bank 1 only deposits 1000 RMB off-chain assets on anchor point 2, because bank 1 obtains 1000 RMB blockchain assets issued by anchor point 2 from bank 2 or another member, bank 1 can hold 2000 RMB blockchain assets issued by anchor point 2. Assume that a blockchain balance of wallet 1 is 1000 RMB blockchain assets issued by anchor point 1; a blockchain balance of bank 1 is 2000 RMB blockchain assets issued by anchor point 2; a blockchain balance of bank 2 is 1000 RMB blockchain assets issued by anchor point 1, 1000 RMB blockchain assets issued by anchor point 2, and 3000 RMB blockchain assets issued by anchor point 3; a blockchain balance of bank 3 is 1000 RMB blockchain assets issued by anchor point 3. After joining the remittance contract, each member is bound by the remittance contract, so that the blockchain balance of each member is recorded on a blockchain ledger of the blockchain. A plurality of accounting nodes (usually greater than four) maintain a unified distributed ledger of the blockchain. The ledger records the blockchain balance of each member. The accounting nodes enable ledger content on all the nodes to be consistent, that is, be full accounting information of the blockchain, through broadcasting between nodes and a consensus algorithm. Therefore, it is considered that all the nodes in the blockchain use the unified ledger, namely, the blockchain ledger. Because the information in the blockchain is tamper-proof and traceable, the information recorded on the blockchain ledger is reliable enough to be trusted by all members and anchor points and can be used as an operating basis in various money transfer scenarios such as transfer and payment.

In addition, members need to record their trustiness to each anchor point on the blockchain ledger for subsequent route determining. For example, as shown in FIG. 3, although wallet 2 does not hold blockchain assets issued by anchor point 3, because wallet 2 sets anchor point 3 as a trusted anchor point, the trust condition is represented by using “the blockchain balance is 0” in FIG. 3, indicating that wallet 2 is willing to receive blockchain assets issued by anchor point 3 (for example, transferred from another member). Anchor point 1 can be an untrusted anchor point of wallet 2, indicating that wallet 2 is not willing to receive blockchain assets issued by anchor point 1.

In the present specification, the member's “trustiness” to the anchor point can be represented as follows: the more a member trusts in the anchor point, the larger the amount of blockchain assets that can be held by the member and are issued by the anchor point. For example, bank 1 setting the amount for anchor point 1 to 2000 RMB indicates that in cases where bank 1 holds blockchain assets issued by anchor point 1 do not exceed 2000 RMB, bank 1 allows anchor point 1 to exchange those blockchain assets for off-chain assets. Otherwise, there can be an asset loss risk. The previous “trustiness” can be referred to as a trustline. For example, the amount that is set by bank 1 for anchor point 1 is 2000 RMB, that is, the trustline that is set by bank 1 for anchor point 1 is 2000 RMB. When one anchor point can support a plurality of types of assets, the member can set corresponding trustlines for different types of assets. For example, for anchor point 1, bank 1 can set trustline 1 corresponding to Hong Kong dollar to $2000, and trustline 2 corresponding to U.S. dollar to $1000. Different trustlines are independent of each other. When the member sets a plurality of trustlines for one anchor point, although these trustlines are independent of each other, these trustlines can be bound by a total amount. Therefore, effective risk control is implemented by using the independent amount indicated by each trustline and the total amount indicated by all trustlines.

In the implementation shown in FIG. 3, a case of a plurality of types of assets is not considered. Assume that assets to be transferred are the same type of asset. Wallet 1 only sets trustline-QB1-1 to 1500 RMB for anchor point 1. Bank 1 sets trustline-YH1-1 to 3000 RMB for anchor point 1, and sets trustline-YH1-2 to 2000 RMB for anchor point 2. Bank 2 sets trustline-YH2-1 to 1200 RMB for anchor point 1, sets trustline-YH2-2 to 1800 RMB for anchor point 2, and sets trustline-YH2-3 to 3500 RMB for anchor point 3. Bank 3 sets trustline-YH3-2 to 1000 RMB for anchor point 2, and sets trustline-YH3-3 to 2000 RMB for anchor point 3. Wallet 2 sets trustline-QB2-2 to 3000 RMB for anchor point 2, and sets trustline-QB2-3 to 2000 RMB for anchor point 3. The trustline that is set by each member for each anchor point is recorded on the blockchain ledger for query and asset transfer control when needed.

In addition, each blockchain member can set a corresponding remittance fee based on a remittance scenario that the blockchain member expects to support. Bank 1 is used as an example. If bank 1 deposits a blockchain balance on each of anchor point 1 and anchor point 2, bank 1 can support remittance between anchor point 1 and anchor point 2, and set a corresponding remittance fee for the remittance. Assume that bank 1 expects to support remittance from anchor point 1 to anchor point 2. It is equivalent to that anchor point 1 can remit a payment, and anchor point 2 can receive a payment, and it is equivalent to that money is remitted from anchor point 1 to anchor point 2. In this case, bank 1 needs to ensure that the following conditions are satisfied:

(1) Blockchain assets that are held by bank 1 and are issued by anchor point 1 are less than trustline-YH1-1; and (2) blockchain assets that are held by bank 1 and are issued by anchor point 2 are greater than 0.

In the implementation shown in FIG. 3, because the blockchain assets that are held by bank 1 and are issued by anchor point 1 are 0, which is less than trustline-YH1-1, and the blockchain assets that are held by bank 1 and are issued by anchor point 2 are 2000 RMB, which is greater than 0 RMB, conditions (1) and (2) are satisfied, and a corresponding remittance fee can be set. For example, the remittance fee is 100 RMB per transaction.

Similarly, bank 1 can set a remittance fee for performing remittance from anchor point 2 to anchor point 1. However, because the blockchain assets that are held by bank 1 and are issued by anchor point 2 are 2000 RMB, which is equal to trustline-YH1-2, and the blockchain assets that are held by bank 1 and are issued by anchor point 1 are 0, conditions (1) and (2) are not satisfied, and a corresponding remittance fee cannot be set. Alternatively, although a remittance fee can be set, bank 1 cannot perform remittance from anchor point 2 to anchor point 1 based on the remittance fee.

Similarly, another blockchain member can also determine whether blockchain assets that are held by the blockchain member and are issued by each anchor point satisfy conditions (1) and (2), to set a corresponding remittance fee for remittance between corresponding anchor points when the two conditions are both satisfied. Details are omitted here.

In the remittance scenario shown in FIG. 3, user 1 can initiate a remittance request to wallet 1, and specify an amount of money to be remitted and a payee in the remittance request. For example, assume that user 1 sets the money amount to 1000 RMB and the payee to user 2. In addition to initiating the remittance request by user 1, another method can be used to trigger the remittance process. For example, user 1 initiates a payment request, where a money amount is 1000 RMB, and a payee is user 2. For another example, user 2 initiates a receiving request, where a money amount is 1000 RMB, and a payer is user 1. No limitation is imposed in the present specification.

Wallet 1 can confirm that a balance in customer account 1 corresponding to user 1 is sufficient, and confirm, to wallet 2, that the payee user 2 exists. When the balance is sufficient and user 2 exists, wallet 1 can perform compliance check on the remittance event initiated by user 1 to user 2. For example, wallet 1 can provide a document submission entry for user 1, and user 1 provides documents to be checked for the remittance event. User 1 can submit in advance static documents (such as the identity card photo of user 1) that can be used for all remittance events, and submit dynamic documents (such as recent remittance records) for a corresponding remittance event each time remittance is performed, to improve remittance efficiency. Compliance check performed by wallet 1 for the remittance event can include at least one of Know Your Customer (KYC) check, Anti-Money Laundering (AML) check, and other types of check. No limitation is imposed in the present specification.

Then, wallet 1 can initiate a “route request” contract operation, to determine a remittance route for performing remittance from wallet 1 to wallet 2. The remittance route includes wallet 1, which is used as the most upstream member, wallet 2, which is used as the most downstream member, and several intermediate members between wallet 1 and wallet 2. Based on the technical solutions in the present specification, blockchain assets that are held by each member in the remittance route and are issued by each anchor point in the blockchain are transferred to present an effect of “a remittance (for example, 1000 RMB that user 1 expects to remit) is transferred from wallet 1 to wallet 2”, and finally wallet 2 provides the remittance for user 2.

When the remittance is transferred among the members in the remittance route, the transfer process can be divided into several times of money transfer between adjacent members. For example, when the remittance route is “wallet 1-intermediate member-wallet 2”, it includes two pairs of adjacent members: “wallet 1-intermediate member” and “intermediate member-wallet 2”, and involves two times of money transfer: transfer from wallet 1 to the intermediate member, and transfer from the intermediate member to wallet 2. In each pair of adjacent members, money transfer needs to be implemented by using an anchor point in the blockchain, and two conditions are involved. Condition (1): blockchain assets that are held by an upstream member in the adjacent members and are issued by a certain anchor point are not less than the remittance amount; condition (2): a downstream member in the adjacent members sets a trustline for the anchor point, and a sum of the remittance amount and blockchain assets that are held by the downstream member and are issued by the anchor point is not greater than the trustline. In other words, there is an associated anchor point between the upstream member and the downstream member, the upstream member has sufficient blockchain assets on the associated anchor point for money transfer, and the downstream member is willing to receive blockchain assets issued by the associated anchor point.

Wallet 1 and bank 1 are used as an example. Blockchain assets that are held by wallet 1 and are issued by anchor point 1 are 1000 RMB, which is not less than the remittance amount of 1000 RMB. Bank 1 sets trustline-YH1-1 to 2000 RMB for anchor point 1. Blockchain assets that are held by bank 1 and are issued by anchor point 1 are 0 RMB, and a sum of the blockchain assets and the remittance amount of 1000 RMB is 1000 RMB, which is less than 2000 RMB. Therefore, anchor point 1 is an associated anchor point between wallet 1 and bank 1, and wallet 1 and bank 1 can implement asset transfer based on anchor point 1.

Wallet 1 and bank 2 are used as an example. Blockchain assets that are held by wallet 1 and are issued by anchor point 1 are 1000 RMB, which is not less than the remittance amount of 1000 RMB. Bank 2 sets trustline-YH2-1 to 1200 RMB for anchor point 1. Blockchain assets that are held by bank 2 and are issued by anchor point 1 are 1000 RMB, and a sum of the blockchain assets and the remittance amount of 1000 RMB is 2000 RMB, which is greater than 1200 RMB. Therefore, anchor point 1 is not an associated anchor point between wallet 1 and bank 2, and wallet 1 and bank 2 cannot implement asset transfer based on anchor point 1.

Similarly, whether members in the blockchain satisfy conditions (1) and (2) can be separately determined by using the previous method, to determine the several intermediate members that can successively connect wallet 1 and wallet 2, and finally obtain the entire remittance route.

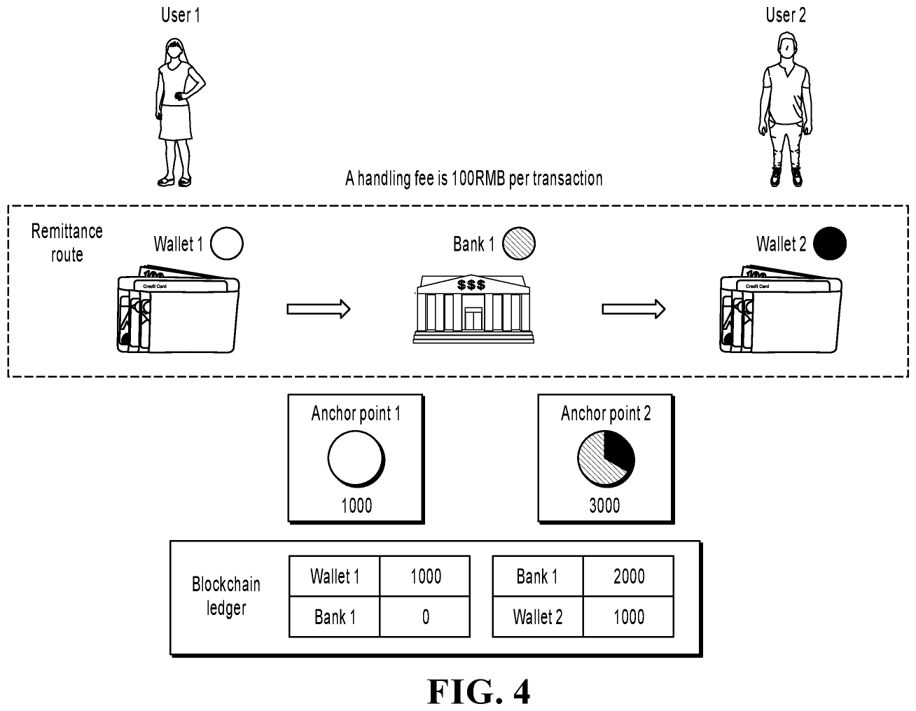

FIG. 4 is a schematic diagram illustrating determining of a remittance route, according to an example implementation. As shown in FIG. 4, the remittance route can include wallet 1-bank 1-wallet 2. An associated anchor point between wallet 1 and bank 1 is anchor point 1, and an associated anchor point between bank 1 and wallet 2 is anchor point 2. Therefore, wallet 1 can read, from the blockchain, a remittance fee that is predetermined by bank 1 and is for performing remittance from anchor point 1 to anchor point 2, for example, 100 RMB per transaction.

In an implementation, wallet 1 can determine a plurality of remittance routes at the same time, and select a final remittance route based on a specific condition. For example, the condition can include the shortest path, the lowest costs. No limitation is imposed in the present specification. Alternatively, wallet 1 can notify user 1 of a path length and a remittance fee involved in each of a plurality of remittance routes, and user 1 selects a final remittance route.

In an implementation, the remittance route can include a plurality of intermediate members, such as wallet 1-bank 2-bank 3-wallet 2 (which not corresponding to the implementation shown in FIG. 3). In this case, wallet 1 needs to separately determine a remittance fee that is set by bank 2 and a remittance fee that is set by bank 3, and uses a sum of the two remittance fees as a total remittance fee. For example, if the remittance fee that is set by bank 2 is 100 RMB per transaction, and the remittance fee that is set by bank 3 is 150 RMB per transaction, the total remittance fee is 250 RMB.

In an implementation, wallet 1 can further initiate a compliance check request for each intermediate member, so that compliance check can be synchronously or asynchronously performed for all the intermediate members. When results of the compliance check are all qualified, wallet 1 initiates a “remittance” contract operation, to transfer money between all members in the remittance route and complete the remittance operation.

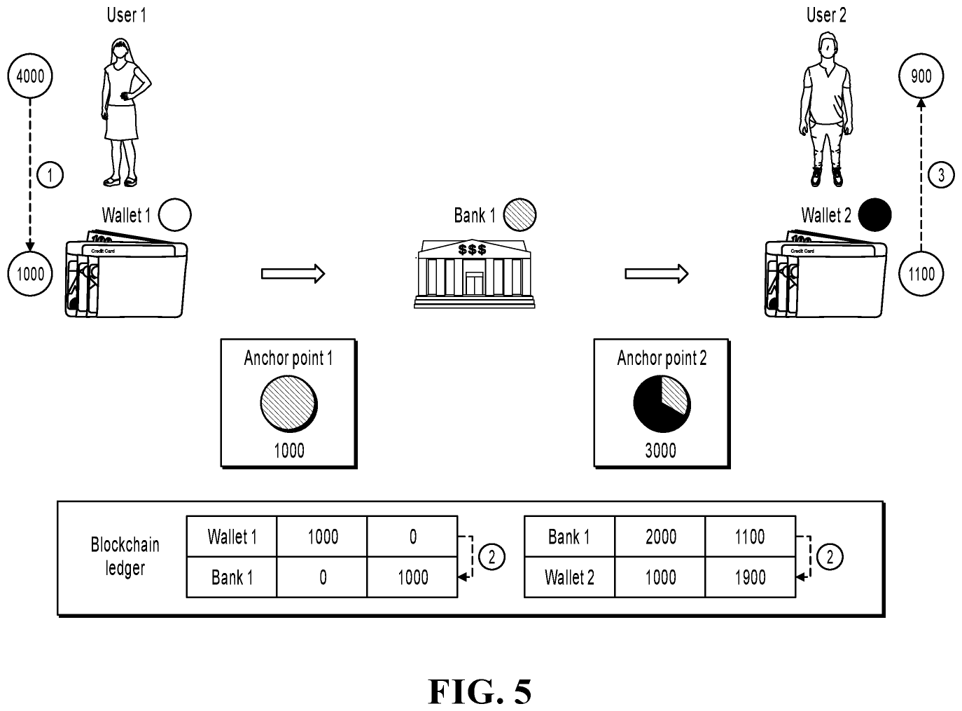

FIG. 5 is a schematic diagram illustrating performing of a remittance operation, according to an example implementation. As shown in FIG. 5, the remittance operation can include the three steps below.

In step \textcircled{1}, wallet 1 can deduct 1000 RMB from customer account 1 corresponding to user 1, and transfer the 1000 RMB to self-owned account 1 of wallet 1.

In step \textcircled{2}, money transfer is implemented between wallet 1 and bank 1 by using anchor point 1, where 1000 RMB is transferred from blockchain assets that are held by wallet 1 and are issued by anchor point 1 to bank 1. As such, the blockchain assets that are held by wallet 1 and are issued by anchor point 1 decrease from 1000 RMB to 0 RMB, and blockchain assets that are held by bank 1 and are issued by anchor point 1 increase from 0 RMB to 1000 RMB. As described above, because bank 1 sets trustline-YH1-1 to 2000 RMB for anchor point 1 and 2000 is greater than a sum of 0 and 1000, money transfer can be implemented on anchor point 1.

In addition, money transfer is implemented between bank 1 and wallet 2 by using anchor point 2. Because a remittance fee that is set by bank 1 is 100 RMB per transaction, 900 RMB (1000 RMB−100 RMB=900 RMB) is transferred from blockchain assets that are held by bank 1 and are issued by anchor point 2 to wallet 2. As such, the blockchain assets that are held by bank 1 and are issued by anchor point 2 decrease from 2000 RMB to 1100 RMB, and blockchain assets that are held by wallet 2 and are issued by anchor point 2 increase from 1000 RMB to 1900 RMB. As described above, because wallet 2 sets trustline-QB2-2 to 3000 RMB for anchor point 2 and 3000 is greater than a sum of 1000 and 1000, money transfer can be implemented on anchor point 2.

In step \textcircled{3}, wallet 2 can transfer 900 RMB from self-owned account 2 to customer account 2 opened by user 2 in wallet 2.

During money transfer between wallet 1 and bank 1 and money transfer between bank 1 and wallet 2, because self-owned account 1 of wallet 1 increases by 1000 RMB transferred from customer account 1 of user 1, and the blockchain assets that are held by wallet 1 and are issued by anchor point 1 decrease by 1000 RMB, the net money transfer of wallet 1 is 0 RMB. Because the blockchain assets that are held by bank 1 and are issued by anchor point 1 increase by 1000 RMB, and the blockchain assets that are held by bank 1 and are issued by anchor point 2 decrease by 900 RMB, it is equivalent to that bank 1 charges a remittance fee of 100 RMB in the money transfer process. Because the blockchain assets that are held by wallet 2 and are issued by anchor point 2 increase by 900 RMB, it is equivalent to that the remaining 900 RMB obtained after bank 1 deducts the remittance fee of 100 RMB from 1000 RMB remitted by user 1 is transferred to a blockchain balance of wallet 2 through the remittance route. Because the blockchain assets that are held by wallet 2 and are issued by anchor point 2 increase by 900 RMB, and then 900 RMB is spent from self-own account 2 of wallet 2, the net money transfer of wallet 2 is 0 RMB, and user 2 obtains the remittance of 900 RMB from user 1.

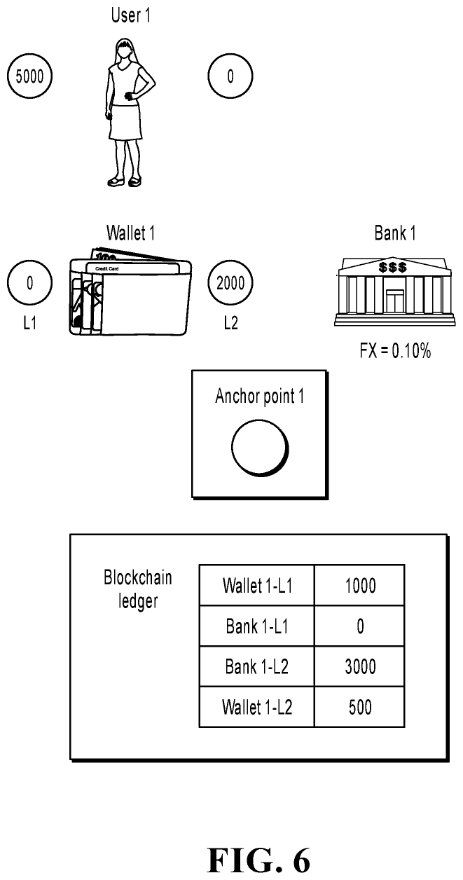

In the implementations shown in FIG. 3 to FIG. 5, transferred-in assets and transferred-out assets during asset transfer are of the same type. In some implementations, a transfer operation involving different types of assets can exist. FIG. 6 is a schematic diagram illustrating asset transfer involving a plurality of types of assets, according to an example implementation. As shown in FIG. 6, assume that bank 1 supports a plurality of types of assets such as L1 and L2. Correspondingly, when bank 1 trusts in anchor point 1, bank 1 can set a corresponding trustline for each type of asset issued by anchor point 1, to indicate trustiness to anchor point 1 for each type of assets. For example, bank 1 can set trustline-YH1-1-L1 to 2000 RMB for assets L1 supported by anchor point 1 and set trustline-YH1-1-L2 to 4000 RMB for assets L2 supported by anchor point 1. An exchange rate between the assets L1 and the assets L2 is 1:2, that is, 1 RMB assets L1 are equivalent to 2 RMB assets L2.

Similarly, wallet 1 also supports a plurality of types of assets such as L1 and L2. In addition, wallet 1 can set trustline-QB1-1-L1 to 1500 RMB for assets L1 supported by anchor point 1, and set trustline-QB1-1-L2 to 3000 RMB for assets L2 supported by anchor point 1.

In an implementation, user 1 can initiate a contract operation to wallet 1 to exchange 1000 RMB assets L1 in customer account 1 for assets L2. Wallet 1 can determine a suitable asset transfer route based on an amount of assets that are held by each blockchain member and are issued by each anchor point, a set trustline, and an asset transfer fee. For details, references can be made to the process of determining a remittance route in the implementations shown in FIG. 3 to FIG. 5. Details are omitted here.

Assume that a remittance route selected by wallet 1 is wallet 1 (L1)-bank 1 (L1)-bank 1 (L2)-wallet 1 (L2), that is, asset transfer is implemented by using blockchain assets L1 and L2 that are respectively held by wallet 1 and bank 1 and are issued by anchor point 1. Because only anchor point 1 is involved, and transfer of assets L1 and L2 is involved, it is equivalent to that asset exchange is implemented on anchor point 1.

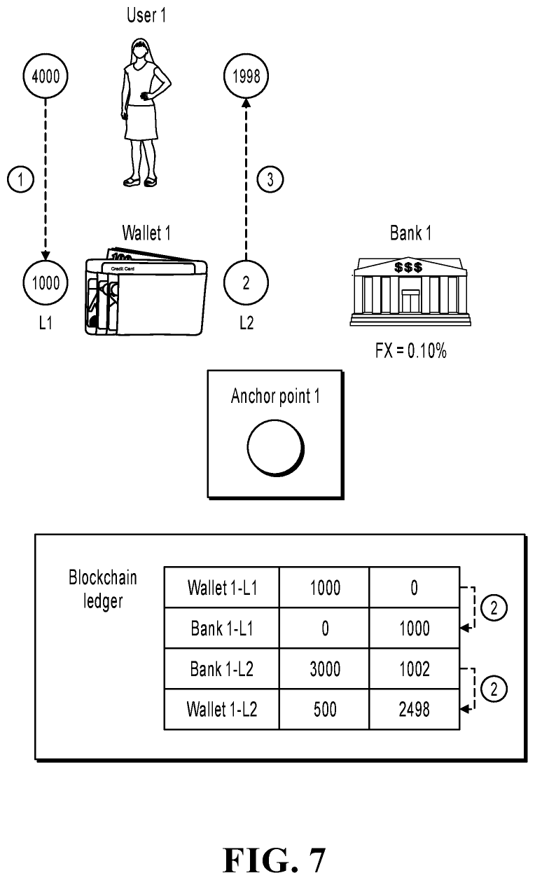

FIG. 7 is a schematic diagram illustrating performing of an asset transfer operation, according to an example implementation. As shown in FIG. 7, the asset transfer operation can include the three steps below.

In step \textcircled{1}, wallet 1 can deduct 1000 RMB from customer account 1-L1 corresponding to user 1, and transfer the 1000 RMB to self-owned account 1-L1 of wallet 1.

In step \textcircled{2}, money transfer is implemented between wallet 1 and bank 1 by using anchor point 1, where 1000 RMB is transferred from blockchain assets L1 that are held by wallet 1 and are issued by anchor point 1 to bank 1. As such, the blockchain assets L1 that are held by wallet 1 and are issued by anchor point 1 decrease from 1000 RMB to 0 RMB, and blockchain assets L1 that are held by bank 1 and are issued by anchor point 1 increase from 0 RMB to 1000 RMB. As described above, because bank 1 sets trustline-YH1-1-L1 to 2000 RMB for anchor point 1 and 2000 is greater than 1000, asset transfer can be implemented on anchor point 1.

In addition, money transfer is implemented between bank 1 and wallet 1 by using anchor point 1. Because an asset transfer fee that is set by bank 1 is FX=0.10%, and an exchange rate between assets L1 and assets L2 is 1:2, 1998 RMB (1000 RMB×2×(1−0.10%)=1998 RMB) is transferred from blockchain assets L2 that are held by bank 1 and are issued by anchor point 1 to wallet 1. As such, the blockchain assets L2 that are held by bank 1 and are issued by anchor point 1 decrease from 3000 RMB to 1002 RMB, and blockchain assets L2 that are held by wallet 1 and are issued by anchor point 1 increase from 500 RMB to 2498 RMB. As described above, because wallet 2 sets trustline-QB1-1-L2 to 3000 RMB for anchor point 1 and 3000 is greater than 2498, asset transfer can be implemented on anchor point 1.

In step \textcircled{3}, wallet 1 can transfer 1998 RMB from self-owned account 1-L2 to customer account 1-L2 opened by user 1 in wallet 1.

During money transfer between wallet 1 and bank 1, because self-owned account 1-L1 of wallet 1 increases by 1000 RMB transferred from customer account 1-L1 of user 1, and the blockchain assets L1 that are held by wallet 1 and are issued by anchor point 1 decrease by 1000 RMB, the net money transfer of wallet 1 is 0 RMB. Because the blockchain assets L1 that are held by bank 1 and are issued by anchor point 1 increase by 1000 RMB, and the blockchain assets L2 that are held by bank 1 and are issued by anchor point 1 decrease by 1998 RMB, it is equivalent to that bank 1 charges an asset transfer fee of 2 RMB of type L2 in the money transfer process. Because the blockchain assets L2 that are held by wallet 1 and are issued by anchor point 1 increase by 1998 RMB, it is equivalent to that the remaining 1998 RMB of type L2 obtained after bank 1 deducts the asset transfer fee of 2 RMB of type L2 from 1000 RMB of type L1 remitted by user 1 is transferred to a blockchain balance of wallet 1 through the remittance route. Because the blockchain assets L2 that are held by wallet 1 and are issued by anchor point 1 increase by 1998 RMB, and then 1998 RMB of type L2 is spent from self-own account 1-L2 of wallet 1, the net money transfer of wallet 1 is 0 RMB, and user 1 obtains 1998 RMB of type L2. In other words, user 1 exchanges 1000 RMB of type L1 for 1998 RMB of type L2.

In some scenarios, the implementations shown in FIG. 3 to FIG. 5 and the implementations shown FIG. 6 and FIG. 7 can be combined, that is, asset transfer among a plurality of anchor points is involved, and asset types on different anchor points are different, so that asset transfer among the plurality of anchor points is involved, and exchange between different types of assets in the asset transfer process is involved. Correspondingly, the blockchain member can separately set a fee in the asset transfer process (similar to the handling fee in FIG. 3 to FIG. 5) and a fee in the asset exchange process (similar to the asset transfer fee in FIG. 6 to FIG. 7), or the blockchain member can set a total fee that is used in both the asset transfer process and the asset exchange process.

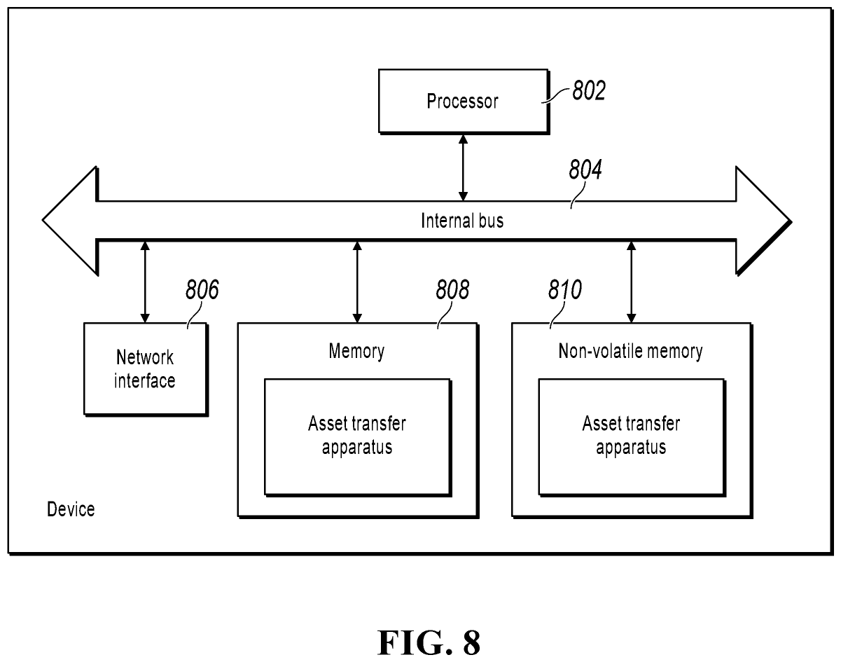

FIG. 8 is a schematic structural diagram illustrating a device, according to an example implementation. As shown in FIG. 8, in terms of hardware, the device includes a processor 802, an internal bus 804, a network interface 806, a memory 808, and a non-volatile memory 810, and certainly can further include the hardware needed by other services. The processor 802 reads a corresponding computer program from the non-volatile memory 810 into the memory 808 and then runs the corresponding computer program, to form an asset transfer apparatus in terms of logic. Certainly, in addition to software implementation, other implementations are not excluded from the one or more implementations of the present specification, for example, a logic device or a combination of hardware and software. That is, an executive body of the following processing procedure is not limited to each logical unit, and can also be hardware or a logic device.

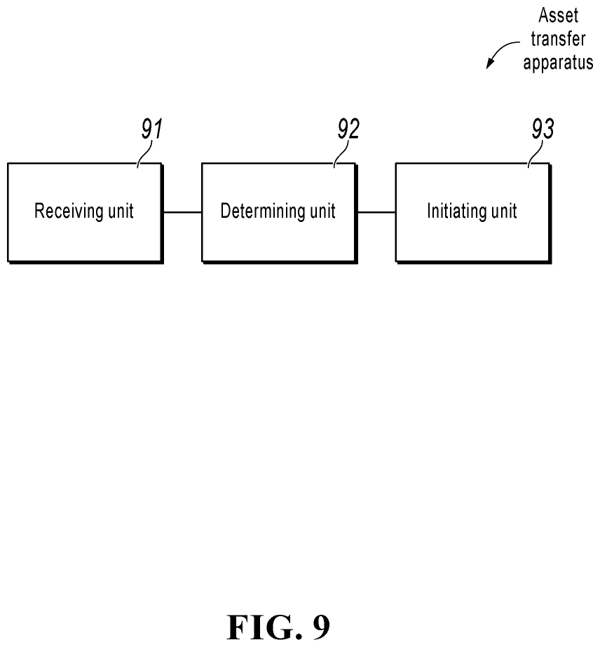

Referring to FIG. 9, in a software implementation, the asset transfer apparatus can include: a receiving unit 91, enabling a first blockchain member to receive a request for transferring a first amount of assets between a payer and a payee; a determining unit 92, enabling the first blockchain member to determine a second blockchain member corresponding to the payee, and several intermediate blockchain members between the first blockchain member and the second blockchain member, where adjacent blockchain members respectively hold blockchain assets issued by a same anchor point; and an initiating unit 93, enabling the first blockchain member to initiate an asset transfer contract operation based on an asset transfer condition published by each intermediate blockchain member, so that after the asset transfer contract operation takes effect, the following operations are completed in a same atomic transaction: each intermediate blockchain member receives, based on blockchain assets that are issued by a first anchor point and are respectively held by the intermediate blockchain member and an upstream neighboring blockchain member, a first amount of blockchain assets that are issued by the first anchor point and are transferred from the upstream neighboring blockchain member, and transfers, based on blockchain assets that are issued by a second anchor point and are respectively held by the intermediate blockchain member and a downstream neighboring blockchain member, a second amount of blockchain assets issued by the second anchor point to the downstream neighboring blockchain member, where the asset transfer condition is used to indicate a numerical relationship between transferred-in assets of a corresponding intermediate blockchain member on the first anchor point and transferred-out assets of the intermediate blockchain member on the second anchor point, so that the first amount and the second amount satisfy the numerical relationship.

Optionally, the asset transfer condition includes: a ratio of an amount of the transferred-out assets to an amount of the transferred-in assets is a predetermined ratio.

Optionally, the asset transfer condition includes: an amount of the transferred-out assets is less than an amount of the transferred-in assets by a predetermined value.

Optionally, the numerical relationship indicated by the asset transfer condition is related to at least one of the following dimensions: an asset type of the transferred-in assets, an asset type of the transferred-out assets, whether the first anchor point and the second anchor point are a same anchor point, a management party of the first anchor point, a management party of the second anchor point, a value range of the first amount, a category of the payer, and a category of the payee.

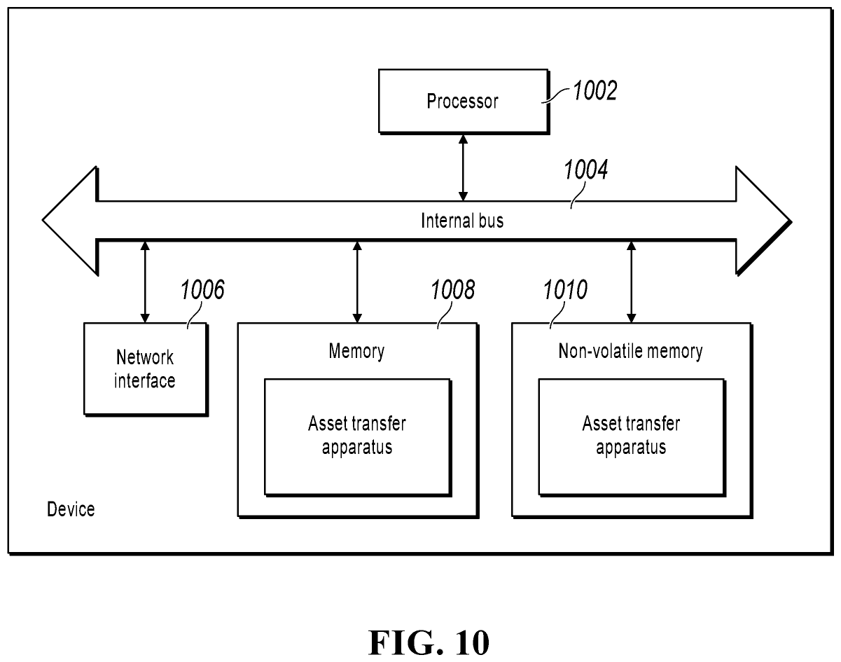

FIG. 10 is a schematic structural diagram illustrating another device, according to an example implementation. As shown in FIG. 10, in terms of hardware, the device includes a processor 1002, an internal bus 1004, a network interface 1006, a memory 1008, and a non-volatile memory 1010, and certainly can further include the hardware needed by other services. The processor 1002 reads a corresponding computer program from the non-volatile memory 1010 into the memory 1008 and then runs the corresponding computer program, to form an asset transfer apparatus in terms of logic. Certainly, in addition to software implementation, other implementations are not excluded from the one or more implementations of the present specification, for example, a logic device or a combination of hardware and software. That is, an executive body of the following processing procedure is not limited to each logical unit, and can also be hardware or a logic device.

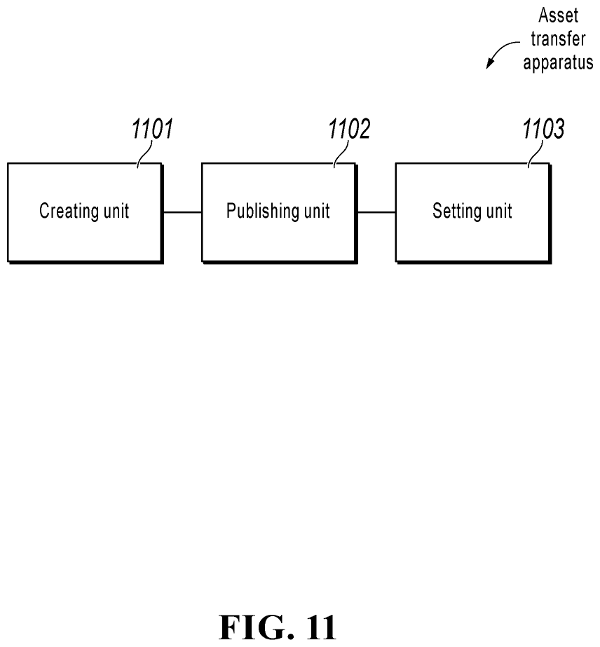

Referring to FIG. 11, in a software implementation, the asset transfer apparatus can include: a creating unit 1101, enabling a blockchain member to create an asset transfer condition, where the asset transfer condition is used to indicate a numerical relationship between transferred-in assets of the blockchain member on a first anchor point and transferred-out assets of the blockchain member on a second anchor point when asset transfer is performed; and a publishing unit 1102, enabling the blockchain member to publish the asset transfer condition in a blockchain, so that when the blockchain member acts as an intermediate blockchain member to implement asset transfer between a payer and a payee, the blockchain member and a first blockchain member used as an upstream neighbor respectively hold blockchain assets issued by the first anchor point, and the blockchain member and a second blockchain member used as a downstream neighbor respectively hold blockchain assets issued by the second anchor point, blockchain assets that are issued by the first anchor point and are transferred from the first blockchain member to the blockchain member and blockchain assets that are issued by the second anchor point and are transferred from the blockchain member to the second blockchain member satisfy the numerical relationship indicated by the asset transfer condition.

Optionally, the creating unit 1101 is specifically configured to enable the blockchain member to create the asset transfer condition when remaining assets that are held by the blockchain member and are respectively issued by the first anchor point and the second anchor point satisfy a predetermined condition.

The predetermined condition includes: the remaining assets that are held by the blockchain member and are issued by the second anchor point are not less than a first predetermined amount, and a remaining amount of assets that can be transferred to the blockchain member and are issued by the first anchor point is not less than a second predetermined amount.

Optionally, the apparatus further includes: a setting unit 1103, enabling the blockchain member to set the asset transfer condition to an invalid state when the remaining assets that are held by the blockchain member and are respectively issued by the first anchor point and the second anchor point do not satisfy the predetermined condition.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, a computer includes one or more processors (CPU), an input/output interface, a network interface, and a memory.

The memory can include a non-persistent memory, a random access memory (RAM), a non-volatile memory, and/or another form in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. A computer storage medium includes but is not limited to a phase-change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a magnetic tape, a magnetic disk storage, a quantum storage, a grapheme-based storage medium, another magnetic storage device, or any other non-transmission medium. The computer storage medium can be used to store information that can be accessed by the computing device. Based on the definition in the present specification, the computer readable medium does not include transitory computer-readable media, for example, a modulated data signal and carrier.

It is worthwhile to further note that the terms “include”, “comprise”, or their any other variant is intended to cover a non-exclusive inclusion, so that a process, a method, a product, or a device that includes a list of elements not only include those elements but also includes other elements which are not expressly listed, or further includes elements inherent to such a process, a method, a product, or a device. An element preceded by “includes a . . . ” does not, without more constraints, preclude the existence of additional identical elements in the process, method, product, or device that includes the element.

Specific implementations of the present specification are described above. Other implementations fall within the scope of the appended claims. In some situations, the actions or steps described in the claims can be performed in an order different from the order in the implementation and the desired results can still be achieved. In addition, the process described in the accompanying drawings does not necessarily require a particular execution order to achieve the desired results. In some implementations, multi-tasking and parallel processing can be advantageous.

The terms used in one or more implementations of the present specification are only for the purpose of describing specific implementations, and are not intended to limit one or more implementations of the present specification. The terms “a” and “the” of singular forms used in the implementations and the appended claims of the present specification are also intended to include plural forms, unless otherwise specified in the context clearly. It should also be understood that, the term “and/or” used in present specification indicates and includes any or all possible combinations of one or more associated listed items.

It should be understood that, although terms “first”, “second”, “third”, etc. can be used to describe various information in the one or more implementations of the present specification, the information is not limited by the terms. These terms are only used to distinguish between information of the same type. For example, without departing from the scope of the one or more implementations of the present specification, first information can also be referred to as second information, and similarly, the second information can also be referred to as the first information. Depending on the context, for example, the word “if” used here can be explained as “while”, “when”, or “in response to determining”.

The previous descriptions are only example implementations in one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

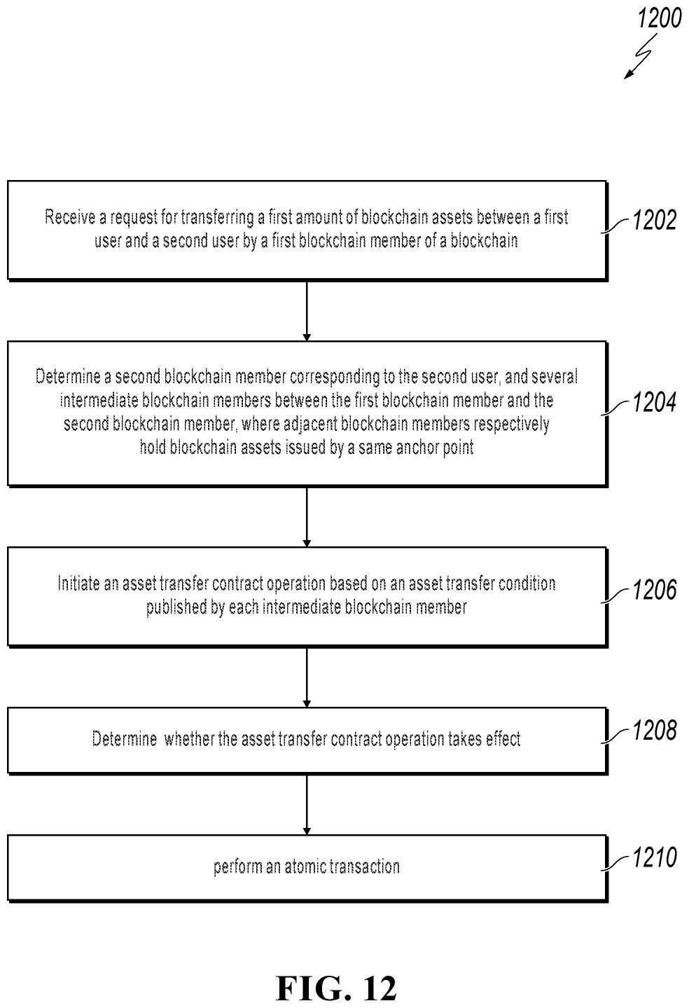

FIG. 12 is a flowchart illustrating an example of a computer-implemented method 1200 for transfer assets in a blockchain network, according to an implementation of the present disclosure. For clarity of presentation, the description that follows generally describes method 1200 in the context of the other figures in this description. However, it will be understood that method 1200 can be performed, for example, by any system, environment, software, and hardware, or a combination of systems, environments, software, and hardware, as appropriate. In some implementations, various steps of method 1200 can be run in parallel, in combination, in loops, or in any order.

At 1202, a request for transferring a first amount of blockchain assets between a first user and a second user is received by a first blockchain member of a blockchain. After 1202, method 1200 proceeds to 1204.

At 1204, a second blockchain member corresponding to the second user, and a number of intermediate blockchain members between the first blockchain member and the second blockchain member are determined by the first blockchain member, where adjacent blockchain members respectively hold blockchain assets issued by a same anchor point. After 1204, method 1200 proceeds to 1206.

At 1206, an asset transfer contract operation is initiated by the first blockchain member and based on an asset transfer condition published by each intermediate blockchain member.

In some implementations, the asset transfer condition includes a ratio of an amount of the transferred-out assets to an amount of the transferred-in assets comprising a predetermined ratio.

In some implementations, the asset transfer condition includes an amount of the transferred-out assets that is less than an amount of the transferred-in assets by a predetermined value. After 1206, method 1200 proceeds to 1208.

At 1208, whether the asset transfer contract operation takes effect is determined by the first blockchain member. After 1208, method 1200 proceeds to 1210.

At 1210, in response to determining that the asset transfer contract operation takes effect, an atomic transaction is performed by the first blockchain member.

In some implementations, performing the atomic transaction includes receiving, by each intermediate blockchain member and based on blockchain assets that are issued by a first anchor point and are respectively held by the intermediate blockchain member and an upstream neighboring blockchain member, the first amount of blockchain assets that are issued by the first anchor point and are transferred from the upstream neighboring blockchain member; and transferring, based on blockchain assets that are issued by a second anchor point and are respectively held by the intermediate blockchain member and a downstream neighboring blockchain member, a second amount of blockchain assets issued by the second anchor point to the downstream neighboring blockchain member, wherein the asset transfer condition is used to indicate a numerical relationship between transferred-in assets of a corresponding intermediate blockchain member on the first anchor point and transferred-out assets of the intermediate blockchain member on the second anchor point, wherein the first amount of blockchain assets and the second amount of blockchain assets satisfy the numerical relationship.

In some implementations, the numerical relationship indicated by the asset transfer condition is related to at least one of an asset type of the transferred-in assets, an asset type of the transferred-out assets, whether the first anchor point and the second anchor point are a same anchor point, a management party of the first anchor point, a management party of the second anchor point, a value range of the first amount of blockchain assets, a category of the first user, and a category of the second user.

In some implementations, method 1200 further includes creating, by the first blockchain member, the asset transfer condition, wherein the asset transfer condition is used to indicate the numerical relationship between transferred-in assets and transferred-out assets of the blockchain member when asset transfer is performed; and publishing, by the first blockchain member, the asset transfer condition in the blockchain. In such implementations, the blockchain member acts as the intermediate blockchain member to implement asset transfer between the first user and the second user.

In some implementations, method 1200 further includes setting, by the blockchain member, the asset transfer condition to an invalid state when the remaining assets that are held by the blockchain member and are respectively issued by the first anchor point and the second anchor point do not satisfy a predetermined condition. After 1210, method 1200 stops.

Implementation of the present application can solve technical problems in assets transfer between blockchain members. Traditionally, asset transfer that is performed between different blockchain members, and asset transfer that is performed between several accounts of one blockchain member does not consider the asset type and the maximum amount of asset a blockchain member is capable to accept. This brought several problems. For example, because each blockchain member has different degree of trust of other blockchain members under for different types of incoming assets, a blockchain member has to go through additional authorization steps to confirm whether the source of incoming assets is trusted. What is needed is a technique to bypass these problems in the conventional methods, and providing a more efficient and secured solution for assets transfer between different blockchain members.

Implementation of the present application provide methods and apparatuses for improving assets transfer between blockchain members. According to these implementations, a unified blockchain ledger is used in the blockchain, and the blockchain ledger records an amount of blockchain assets that are held by each member and are issued by each anchor point. As such, after the asset transfer contract operation is initiated, balances of the first blockchain member, the second blockchain member, and each intermediate blockchain member can be changed together based on the contract operation. The same transaction is completed through cooperation between different institutions, and the asset transfer operation is completed in the same atomic transaction, instead of sequentially performing asset transfers between members. It greatly improves asset transfer efficiency, making it possible to perform real-time, quasi-real-time, or near real-time asset transfer.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method for transferring assets, comprising:
creating, by a blockchain member of a blockchain, an asset transfer condition, wherein the asset transfer condition is used to indicate a numerical relationship between transferred-in assets and transferred-out assets of the blockchain member when an asset transfer is performed; and
publishing, by the blockchain member, the asset transfer condition in the blockchain to realize an asset transfer between a payer and a payee, wherein the blockchain member serves as an intermediate blockchain member between the payer and the payee, wherein:
the blockchain member and an upstream neighboring blockchain member hold respective assets that are issued by a first anchor point,
the blockchain member and a downstream neighboring blockchain member hold respective assets that are issued by a second anchor point, and
the numerical relationship is satisfied by transferred-in assets from the upstream neighboring blockchain member issued by the first anchor point and transferred-out assets of the blockchain member to the downstream neighboring blockchain member issued by the second anchor point.

2. The computer-implemented method of claim 1, wherein creating, by the blockchain member, the asset transfer condition comprises creating, by the blockchain member, the asset transfer condition if remaining assets held by the blockchain member and issued by the first anchor point and remaining assets held by the blockchain member and issued by the second anchor point satisfy a predetermined condition, wherein the predetermined condition comprises that:
the remaining assets held by the blockchain member and issued by the second anchor point is not less than a first predetermined value, and
the remaining assets held by the blockchain member and issued by the first anchor point allows an amount of assets issued by the first anchor point to be transferred in to the blockchain member, and the amount of the assets issued by the first anchor point to be transferred in to the blockchain member is no less than a second predetermined.

3. The computer-implemented method of claim 1, further comprising:
setting, by the blockchain member, the asset transfer condition to an invalid state if remaining assets held by the blockchain member and issued by the first anchor point and remaining assets held by the blockchain member and issued by the second anchor point do not satisfy a predetermined condition.

4. A non-transitory, computer-readable medium storing one or more instructions executable by a computer system to perform operations comprising:
creating, by a blockchain member of a blockchain, an asset transfer condition, wherein the asset transfer condition is used to indicate a numerical relationship between transferred-in assets and transferred-out assets of the blockchain member when an asset transfer is performed; and
publishing, by the blockchain member, the asset transfer condition in the blockchain to realize an asset transfer between a payer and a payee, wherein the blockchain member serves as an intermediate blockchain member between the payer and the payee, wherein:
the blockchain member and an upstream neighboring blockchain member hold respective assets that are issued by a first anchor point,
the blockchain member and a downstream neighboring blockchain member hold respective assets that are issued by a second anchor point, and
the numerical relationship is satisfied by transferred-in assets from the upstream neighboring blockchain member issued by the first anchor point and transferred-out assets of the blockchain member to the downstream neighboring blockchain member issued by the second anchor point.

5. The non-transitory, computer-readable medium of claim 4, wherein creating, by the blockchain member, the asset transfer condition comprises creating, by the blockchain member, the asset transfer condition if remaining assets held by the blockchain member and issued by the first anchor point and remaining assets held by the blockchain member and issued by the second anchor point satisfy a predetermined condition, wherein the predetermined condition comprises that:
the remaining assets held by the blockchain member and issued by the second anchor point is not less than a first predetermined value, and
the remaining assets held by the blockchain member and issued by the first anchor point allows an amount of assets issued by the first anchor point to be transferred in to the blockchain member, and the amount of the assets issued by the first anchor point to be transferred in to the blockchain member is no less than a second predetermined.

6. The non-transitory, computer-readable medium of claim 4, wherein the operations comprise:
setting, by the blockchain member, the asset transfer condition to an invalid state if remaining assets held by the blockchain member and issued by the first anchor point and remaining assets held by the blockchain member and issued by the second anchor point do not satisfy a predetermined condition.

7. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
creating, by a blockchain member of a blockchain, an asset transfer condition, wherein the asset transfer condition is used to indicate a numerical relationship between transferred-in assets and transferred-out assets of the blockchain member when an asset transfer is performed; and
publishing, by the blockchain member, the asset transfer condition in the blockchain to realize an asset transfer between a payer and a payee, wherein the blockchain member serves as an intermediate blockchain member between the payer and the payee, wherein:
the blockchain member and an upstream neighboring blockchain member hold respective assets that are issued by a first anchor point,
the blockchain member and a downstream neighboring blockchain member hold respective assets that are issued by a second anchor point, and
the numerical relationship is satisfied by transferred-in assets from the upstream neighboring blockchain member issued by the first anchor point and transferred-out assets of the blockchain member to the downstream neighboring blockchain member issued by the second anchor point.

8. The computer-implemented system of claim 7, wherein creating, by the blockchain member, the asset transfer condition comprises creating, by the blockchain member, the asset transfer condition if remaining assets held by the blockchain member and issued by the first anchor point and remaining assets held by the blockchain member and issued by the second anchor point satisfy a predetermined condition, wherein the predetermined condition comprises that:
the remaining assets held by the blockchain member and issued by the second anchor point is not less than a first predetermined value, and
the remaining assets held by the blockchain member and issued by the first anchor point allows an amount of assets issued by the first anchor point to be transferred in to the blockchain member, and the amount of the assets issued by the first anchor point to be transferred in to the blockchain member is no less than a second predetermined.

9. The computer-implemented system of claim 7, wherein the one or more operations comprise:
setting, by the blockchain member, the asset transfer condition to an invalid state if remaining assets held by the blockchain member and issued by the first anchor point and remaining assets held by the blockchain member and issued by the second anchor point do not satisfy a predetermined condition.
